(19) United States
(12) Patent Application Publication
(10) Pub. No.: US 2017/0100852 A1
(43) Pub. Date: Apr. 13, 2017

(54) Guide Bar

(71) Applicant: Andreas Stihl AG & Co. KG, Waiblingen (DE)

(72) Inventor: Werner Galster, Aspach (DE)

(21) Appl. No.: 15/270,051

(22) Filed: Sep. 20, 2016

(30) Foreign Application Priority Data
Oct. 7, 2015 (DE) 10 2015 012 974.0

(51) Int. Cl. B27B 17/02

(52) U.S. Cl. CPC B27B 17/025

(57) ABSTRACT

A guide bar for a saw chain has oppositely arranged outer side faces facing away from each other. A guide groove is formed on a peripheral edge of the guide bar and receives and guides the saw chain. The guide bar has a longitudinal center axis and extends lengthwise in a length direction along the longitudinal center axis. A rearward clamping end is provided for securing the guide bar. A leading deflecting section deflects the saw chain and the deflecting section is arranged opposite the rearward clamping end in the length direction. A cutout is formed between the rearward clamping end and the leading deflecting section. A weight-reducing insert is inserted into the cutout and is provided with external elevations that are projecting past a plane of the sides faces of the guide bar.

### BACKGROUND OF THE INVENTION

The invention relates to a guide bar for a saw chain. The guide bar comprises outwardly facing side faces and a guide groove formed in a peripheral edge of the guide bar for guiding the saw chain. The guide bar extends lengthwise along a longitudinal center axis and comprises a rearward clamping end for securing the guide bar and a leading deflecting section for deflecting the saw chain. The guide bar further comprises a cutout which is formed between the clamping end and the deflecting section in the guide bar and is filled with a weight-reducing insert.

U.S. Pat. No. 4,961,263 discloses a guide bar of a motor chainsaw with a cutout which is filled with a weight-reducing fill member.

### SUMMARY OF THE INVENTION

It is an object of the present invention to design a guide bar of the aforementioned kind in such a way that the guide bar has a minimal weight and ensures a precise guiding action for cutting.

In accordance with the present invention, this is achieved in that the insert has external elevations that project past a plane of a side face of the guide bar.

By providing the insert with external elevations that project past the plane of the side face of the guide bar, the contact surface between the guide bar and the kerf is reduced. This leads to reduced friction between the guide bar and the sides of the kerf. Surprisingly, it was found that the tendency of the guide bar to pull to one side during cutting is reduced. This provides for a more precise cutting action.

Due to the external elevations, it is prevented that parts of the guide bar which project past the planes of the side faces hook on the sides of the kerf. For example, such projecting parts can be a rivet for attachment of a bearing for a sprocket wheel in the deflecting section. For example, it is also possible that a burr forms at the guide groove in operation. By action of the saw chain, the burr is formed on the edge of the guide groove which is facing the saw chain. The burr is formed by two pointedly tapering surfaces of a groove wall. The pointedly tapering groove walls are oriented in the direction away from the plane of a side face of the guide bar and away from the guide groove in outward direction. The external elevations according to the invention prevent generally hooking of the burr in the kerf. During cutting, a spacing results between the burr and the sides of the kerf due to the elevations.

Due to the external elevations, the areas of the plane of a side face where no elevations are provided are protected from wear. In these areas, lettering or operating information can be applied without there being the risk of them wearing off when performing cuts.

Advantageously, the elevations are formed monolithic with the insert. In this way, the elevations are connected reliably and safely with the insert and can be produced in a simple way.

Advantageously, the insert is made of plastic material. This reduces the weight of the guide bar. Plastic materials can be simply processed and shaped. Accordingly, manufacture of the elevations is possible in a simple way.

Advantageously, the elevations are arranged along the longitudinal center axis of the guide bar. The elevations can be arranged on the longitudinal center axis as well as parallel thereto. The elevations provide contact points between the sides of the cut groove (kerf) and the guide bar along the longitudinal center axis of the guide bar. By arranging the elevations along the longitudinal center axis of the guide bar, it is ensured that the guide bar has punctiform contact at its center. A support action of the guide bar in this area is advantageous.

Advantageously, the elevations are positioned with equidistant spacing relative to each other. In this way, a uniform distribution of the elevations across that section of the side faces of the guide bar that is formed by the insert is provided. This contributes to a uniform support action of the guide bar during cutting.

Advantageously, the elevations are arranged along a rim of the cutout. In this way, a good utilization of the space that is available on the face of the insert is provided. In this way, the contact points which are arranged along the rim of the cutout are spaced from each other and form a reliable support surface of the guide bar.

Advantageously, the elevations are arranged symmetrical relative to the longitudinal center axis of the guide bar. In this way, a good guiding action of the guide bar is provided.

Expediently, the elevations are knobs. In this way, the contact surface area between the object to be sawed and the guide bar is reduced and the guide bar can be guided more easily during use.

Advantageously, the elevations have the shape of a spherical cap; this shape counteracts canting. When contacting an elevation in the form of a spherical cap, there is always contact to a rounded area.

Advantageously, the height of an elevation is smaller than the radius of the base surface (footprint) of the elevation. This provides high stability of the elevations under load.

### BRIEF DESCRIPTION OF THE DRAWING

FIG. 1 is a schematic perspective illustration of a motor chainsaw with a guide bar.

FIG. 2 is an exploded illustration of a housing part of the motor chainsaw according to FIG. 1.

FIG. 3 is a perspective detail illustration of the guide bar of FIGS. 1 and 2.

FIG. 4 is a schematic side view of the guide bar of FIG. 3.

FIG. 5 shows a section view along the section line V-V of FIG. 4.

FIG. 6 shows a detail view of detail VI of FIG. 5.

FIG. 7 shows a detail view of an alternative embodiment at a location analog to the location of FIG. 6.

### DESCRIPTION OF THE PREFERRED EMBODIMENTS

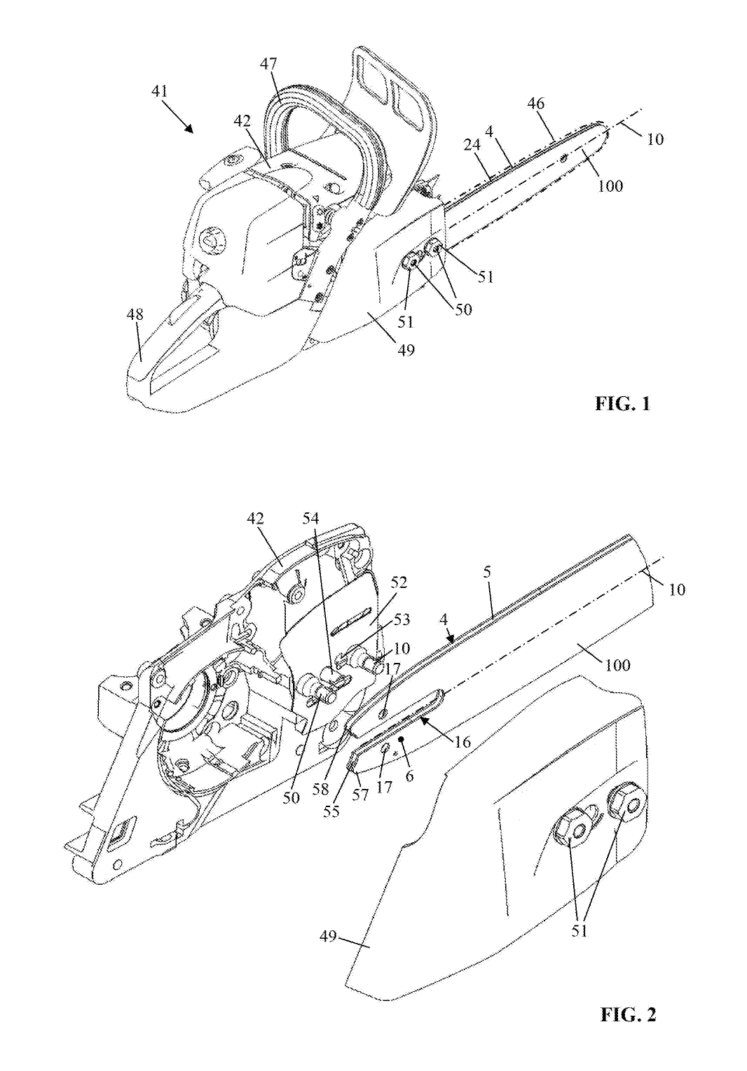

FIG. 1 shows a portable hand-guided motor chainsaw 41. The motor chainsaw 41 comprises a housing 42 in which a drive motor is arranged. As a drive motor, an internal combustion engine, for example, a two-stroke engine, a four-stroke engine, or an electric motor can be provided. For carrying and guiding the motor chainsaw 41, a front handle 47, on the one hand, and a rear handle 48, on the other hand, are provided. The rear handle 48 extends in longitudinal direction of a longitudinal axis of the motor chainsaw 41. The front handle 47 is a curved handle bar which is extending transverse to the longitudinal axis above the housing 42.

On the housing 42 a guide bar 100 is secured which is extending forwardly in the direction of the longitudinal axis of the motor chainsaw 41 past a leading end face of the housing 42. The guide bar 100 is secured by being clamped at one of its ends between the housing 42 of the motor chainsaw 41 and a sprocket wheel cover 49. For this purpose, on the housing 42 two stud bolts 50 are provided which are penetrating a longitudinal slot 16, illustrated in FIG. 2, in a rearward clamping end 6 of the guide bar 100. The sprocket wheel cover 49 is placed onto the stud bolts 50 and secured by a respective nut 51 on the exterior side of the sprocket wheel cover 49. The nuts 51 are tightened securely so that the sprocket wheel cover 49 secures and clamps the clamping end 6 of the guide bar 100 against the housing 42; in this way, the clamping end 6 is connected fixedly to the housing 42. The saw chain 46, schematically indicated in FIG. 1, is guided on the guide bar 100.

The exploded view of FIG. 2 shows that on the housing 42 a side sheet 52 is secured that is in particular made of steel; preferably, it is secured by means of a screw 53. Between the two stud bolts 50 an adjusting screw 54 is provided which is accessible from the exterior of the motor chainsaw 41 via a hole in the sprocket wheel cover 49 and the longitudinal slot 16 in the guide bar 100. The adjusting screw 54 drives a chain tensioning device which is positioned underneath the side sheet 52 and eng ages, preferably by means of a follower, openings 17 in the clamping end 6 of the guide bar 100. Prior to completely tightening the nuts 51, the guide bar 41 can be moved in the longitudinal direction of the motor chainsaw 41 by rotation of the adjusting screw 54 in order to adjust the chain tension of the saw chain 46 guided on the guide bar 100. Usually, the nuts 51 are only subsequently tightened completely so as to clamp and secure the guide bar 100 in this way between sprocket wheel cover 49 and housing 42.

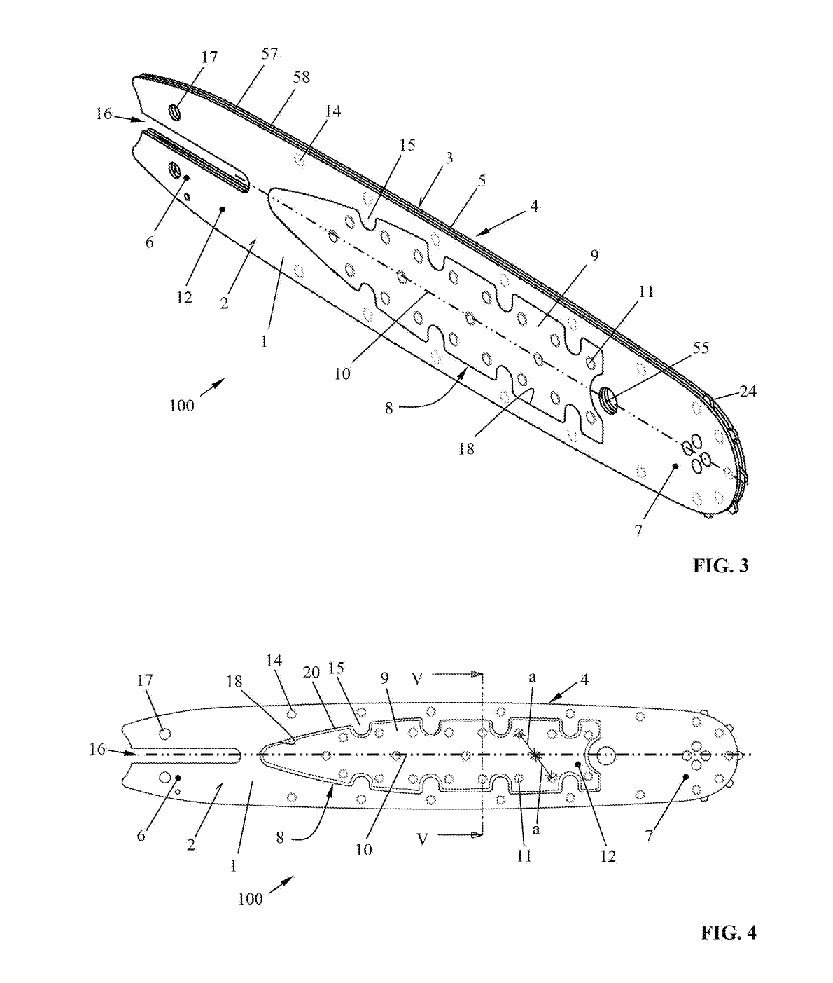

FIG. 3 shows the guide bar 100 of FIG. 1 and FIG. 2 in a perspective detail view. The guide bar 100 comprises side faces 2, 3 and a peripheral edge 4. In the peripheral edge 4 of the guide bar 100 a guide groove 5 for guiding the saw chain 46 is formed.

In the embodiment according to FIGS. 1 to 6, a so-called constructed guide bar 100 is provided. In such constructed guide bars, the base member of the guide bar is of a multi-part configuration and is comprised of several individual parts. However, it can also be provided that the base member of the guide bar is of a monolithic configuration.

In the embodiment, the base member 1 of the guide bar 100 is comprised of the side plates 57, 58 and the spacer 55. The side plates 57, 50 have identical dimensions. The spacer 55 positioned between the side plates 57, 58 is advantageously a spacer plate whose outer dimensions are smaller than those of the side plates 57, 58. Between the rim areas of the side plates 57, 58 the guide groove 5 is formed. The outer rim of the spacer 55 forms advantageously the groove base. The saw chain 46 is guided in the guide groove 5.

The guide bar 100 extends lengthwise in the length direction along the longitudinal center axis 10 and comprises, in addition to the rearward clamping end 6 for securing the guide bar 100, a leading deflecting section 7 with a sprocket wheel 24 for deflecting the saw chain. Between the clamping end 6 and the deflecting section 7 a cutout 8 is formed which is filled with a weight-reducing insert 9. The cutout 8 in the base member 1 of the guide bar 100 forms an areal opening that is extending through both outer side faces 2, 3 of the guide bar 100 transverse to the longitudinal center axis 10 of the guide bar 100. The surface area of the cutout 8 in the side faces 2, 3 of the guide bar 100 is more than one fourth of the entire surface area of the side faces 2, 3 inclusive of the surface area of the cutout 8. As can be seen in FIG. 4, the cutout 8 is substantially V-shaped in a side view wherein the two upper ends of the “V” are connected to each other and the tip of the “V” is pointing in the direction of the rearward clamping end 6.

The insert 9 is comprised of a plastic material and is connected with form fit to the base member 1 of the guide bar 100. The base member 1 comprises fastening projections 15 which are arranged on a rim 18 of the cutout 8 and project into the cutout 8. As can be seen in FIG. 4, the fastening projections 15 in a side view of the outer side faces 2, 3 of the guide bar 100 are substantially U-shaped wherein the closed bottom part of the “U” projects into the cutout 8. The longitudinal direction of the projections 15 is mostly oriented transversely to the longitudinal center axis 10 and parallel to the side faces 2, 3 of the guide bar 100. The longitudinal direction of a fastening projection 15 is oriented however also parallel to the longitudinal center axis 10 of the guide bar. All fastening projections 15 form a flat and planar extension of the side faces 2, 3 of the guide bar 100. The form fit connection between the insert 9 and the fastening projections 15 secures fixedly the position of the insert 9 in the direction of the longitudinal center axis 10 and in the direction transverse to the longitudinal center axis 10 and parallel to the side faces 2, 3.

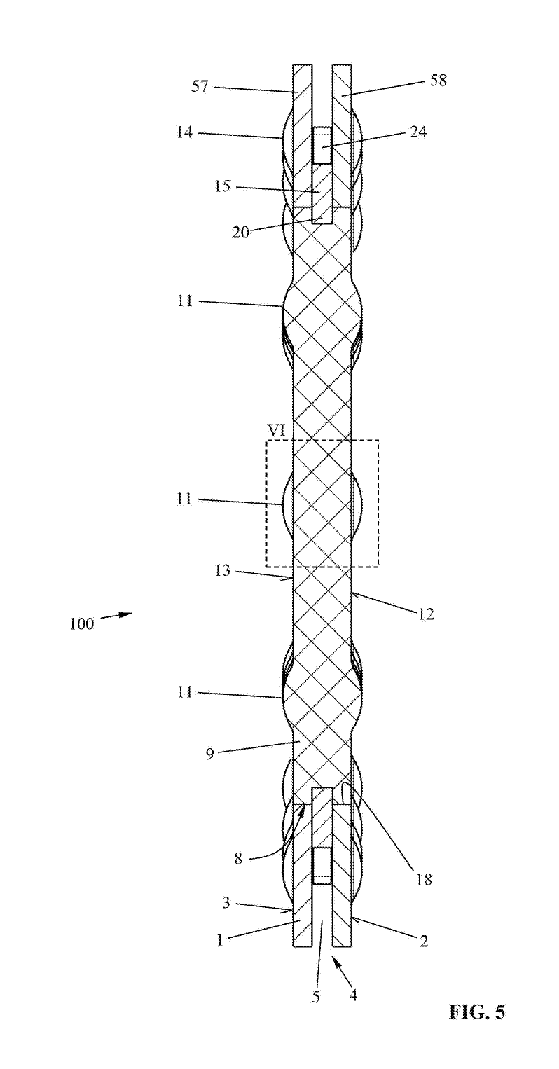

The dimensions of the cutouts in the two side plates 57, 58 correspond with each other. The dimension of the cutout in the spacer 55 is somewhat smaller than the dimension of the cutouts of the side plates 57, 58. In this way, the spacer 55 forms a rib 20 which is indicated in FIG. 4 by a dashed line and is peripherally extending in the cutout 8. In the direction transverse to the longitudinal center axis 10 and perpendicular to the outer side faces 2, 3 of the guide bar 100, the rib 20 is projecting centrally between the side plates 57 and 58 into the cutout 8. As shown in FIG. 5, the insert 9 engages about the rib 20 on the side of the side plate 57 as well as on the side of the side plate 58 in a form fit manner. This form fit between the insert 9 and the projecting rib 20 secures the position of the insert 9 in the cutout 8 of the base member 1 in the direction transverse to the longitudinal center axis 10 of the guide bar 100 and perpendicular to the planes 12, 13 of the outer side faces 2, 3 of the guide bar 100. Due to the form-fit connection of the insert 9 and of the guide bar 100, the position of the insert 9 in the cutout 8 of the guide bar 10 is secured and fixed unequivocally.

The insert 9 comprises external elevations 11 that, as shown in FIG. 5, project past the planes 12, 13 of the side faces 2, 3 of the guide bar 100. However, the elevations 11 are not projecting past the planes 12, 13 of the side faces 2, 3 farther than the cutting edges of the cutting members (not shown) of the saw chain 46. The elevations 11 are formed monolithic with the insert 9. The elevations 11 are comprised completely of plastic material. The elevations 11 are formed without cavities. The elevations 11 are arranged along the longitudinal center axis 10 of the guide bar 100, as can be seen in FIG. 4. The elevations 11 are arranged along a rim 18 of the cutouts 8.

As is shown in FIG. 4, on a side of the insert 9 the elevations 11 are positioned equidistantly spaced at a spacing a relative to each other in the plane 12, 13 of the outer side faces 2, 3 of the guide bar 100. The elevations 11 are symmetrically arranged relative to the longitudinal center axis 10 of the guide bar 100.

As can be seen in FIG. 5, the elevations 11 are knobs.

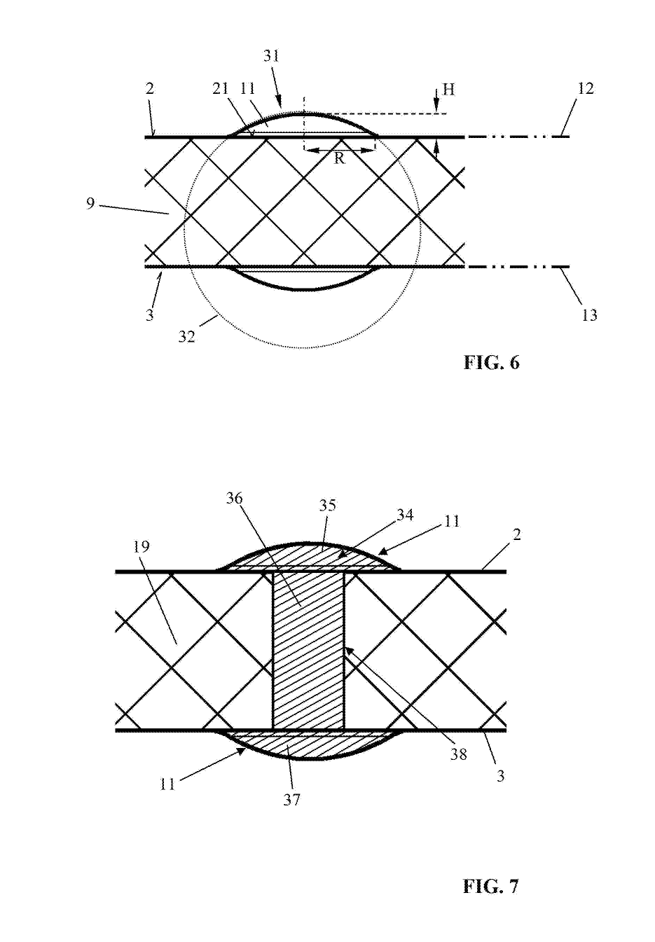

In the detail illustration of FIG. 6, it can be seen that the elevations 11 have the shape of a spherical cap 31. The section of an imaginary sphere 32 corresponding to the spherical cap 31 is indicated in FIG. 6 in a dashed line illustration. The diameter of this sphere 32 is greater than the thickness of the insert 9.

The height H of an elevation 11 is the greatest spacing of the elevation 11 relative to the plane 12, 13 of the side face 2, 3. The base surface 21 of an elevation 11 is positioned in the plane 12, 13 of the side face 2, 3. The base surface 21 of the elevation 11 that has the shape of a spherical cap 31 is circular. The corresponding circle which is positioned in the plane 12, 13 of the outer side face 2, 3 has a radius R. The height H of an elevation 11 is smaller than the radius R of the base surface 21 of an elevation 11. Advantageously, the height H approximately amounts to half of the length of the radius R.

The base surface 21 of an elevation 11 is less than one hundredth of the total surface area of the side surface of the insert 9. The base surfaces 21 of all elevations 11 on a side of the insert 9 is less than one fifth of the total surface area of the side surface of the insert 9.

In FIGS. 3 to 5, embossments 14 in the outer side face 2, 3 of the side plates 57, 58 are illustrated. The embossments 14 are arranged along the outer rim of the side plate 57, 58 in the area of the guide groove. The embossments 14 constitute projections that project past the plane 12, 13 of the outer side face 2, 3 of the guide bar 100. As can be seen in FIG. 5, the outer shape of the embossments 14 corresponds to the outer shape of the spherical elevations 11 of the insert 9. When performing a cut into an object to be sawed, the embossments 14 as well as the elevations 11 provide contact points for contact of the guide bar 100 with the sidewalls of a cut groove (kerf).

FIG. 7 shows an alternative embodiment for the configuration of the external elevations 11 of an alternative insert 19. The alternative insert 19 comprises the same outer contour as the insert 9 according to FIG. 3 to FIG. 5. FIG. 7 shows in analogy to FIG. 6 a detail view of the insert 19 at the same location of the insert 19 as marked in FIG. 5 for insert 9 with the dashed line frame for the detail VI.

The difference to the insert 9 according to FIGS. 3 to 6 resides in that the external elevations 11 at least partially are formed by rivets 34. FIG. 7 shows the arrangement of such a rivet 34. In the insert 19 a hole 38 that extends perpendicular to the outer side faces 2, 3 is arranged and penetrates the insert 19 completely. In the hole 38 a rivet 34 is arranged. The rivet 34 comprises a factory head 35, a shaft 36, and a buck-tail head 37. The hole 38 is covered and closed by the factory head 35 of the rivet 34 and also by the buck-tail head 37 of the rivet 34. The factory head 35 and the buck-tail head 37 of the rivet 34 are positioned opposite each other and contact the outer side faces 2, 3 of the insert 19. The insert 19 is arranged between factory head 35 and buck-tail head 37. The shaft 36 connects the factory head 35 with the buck-tail head 37 and is arranged in the hole 38. In this way, the rivet 34 is fixedly connected with the insert 19. The factory head 35 has the shape of a spherical cap facing in the same direction as the outer side face 2 and forms in this way an external elevation 11. The buck-tail head 37 has the shape of a spherical cap facing in the same direction as the outer side face 3 and forms therefore the external elevation 11.

It can also be provided that the external elevations are realized by adhesively attaching spherical cap shaped elements to the outer side faces on the guide bar.

The specification incorporates by reference the entire disclosure of German priority document 10 2015 012 974.0 having a filing date of Oct. 7, 2015.

While specific embodiments of the invention have been shown and described in detail to illustrate the inventive principles, it will be understood that the invention may be embodied otherwise without departing from such principles.

What is claimed is:

1. A guide bar for a saw chain, the guide bar comprising:
oppositely arranged outer side faces facing away from each other;
a guide groove formed on a peripheral edge of the guide bar and configured to receive and guide a saw chain;
wherein the guide bar comprises a longitudinal center axis and extends lengthwise in a length direction along the longitudinal center axis;
a rearward clamping end for securing the guide bar;
a leading deflecting section for deflecting the saw chain, the leading deflecting section arranged opposite the rearward clamping end in the length direction;
a cutout formed between the rearward clamping end and the leading deflecting section;
a weight-reducing insert inserted into the cutout;
wherein the weight-reducing insert comprises external elevations that are projecting past a plane of the sides faces of the guide bar.

2. The guide bar according to claim 1, wherein the elevations are monolithically formed together with the weight-reducing insert.

3. The guide part according to claim 1, wherein the weight-reducing insert is made of plastic material.

4. The guide bar according to claim 1, wherein the elevations are arranged along the longitudinal center axis of the guide bar.

5. The guide bar according to claim 1, wherein the elevations are equidistantly positioned at an equidistant spacing relative to each other.

6. The guide bar according to claim 1, wherein the elevations are arranged along a rim of the cutout.

7. The guide bar according to claim 1, wherein the elevations are arranged symmetrically relative to the longitudinal center axis of the guide bar.

8. The guide bar according to claim 1, wherein the elevations are knobs.

9. The guide bar according to claim 1, wherein the elevations have the shape of a spherical cap.

10. The guide bar according to claim 1, wherein the elevations each have a base surface with a radius and the elevations each have a height, wherein the height is smaller than the radius of the base surface.
